(19) United States
(12) Patent Application Publication
(10) Pub. No.: US 2026/0112858 A1
(43) Pub. Date: Apr. 23, 2026

(54) DATA GENERATION DEVICE, DATA GENERATION METHOD, AND NON-TRANSITORY STORAGE MEDIUM

(71) Applicant: HAMAMATSU PHOTONICS K.K., Hamamatsu-shi (JP)

(72) Inventors: Ryu NIIGAKI, Shizuoka (JP); Koyo WATANABE, Shizuoka (JP); Kyohei SHIGEMATSU, Shizuoka (JP); Kazuki KAWAI, Shizuoka (JP)

(73) Assignee: HAMAMATSU PHOTONICS K.K., Hamamatsu-shi (JP)

(21) Appl. No.: 19/357,492

(22) Filed: Oct. 14, 2025

(30) Foreign Application Priority Data
Oct. 23, 2024 (JP) 2024-186916

(51) Int. Cl. H01S 3/00; B23K 26/06; B23K 26/0622; H01S 3/13

(52) U.S. Cl. CPC H01S 3/0057; B23K 26/0622; B23K 26/0648; H01S 3/0071; H01S 3/1305

(57) ABSTRACT

A data generation device is a device for generating data to control an SLM for shaping a light pulse for laser processing, and comprises at least one processor configured to: set information regarding a plurality of mutually different temporal-intensity waveforms each including a plurality of light pulses; generate each of a plurality of sets of an intensity spectrum function and a phase spectrum function based on each of the plurality of temporal-intensity waveforms; generate each of a plurality of pieces of data based on each of the plurality of sets of the intensity spectrum function and the phase spectrum function; and calculate a generation efficiency in the SLM for each of the plurality of temporal-intensity waveforms based on each of the plurality of pieces of data and determine data for controlling the SLM from among the plurality of pieces of data based on the generation efficiency.

Priority is claimed on Japanese Patent Application No. 2024-186916, filed on Oct. 23, 2024, the entire content of which is incorporated herein by reference.

### TECHNICAL FIELD

The present disclosure relates to a data generation device, a data generation method, and a non-transitory storage medium.

### BACKGROUND

Conventionally, a technique for shaping a light pulse for laser processing using a spatial light modulator (SLM) is known. The SLM shapes the temporal waveform of the light pulse by modulating the intensity spectrum and phase spectrum of the light pulse. By using a plurality of pulses generated by modulating a single pulse using an SLM for laser processing, the processing efficiency of the laser processing can be improved (for example, see Du, Kun, et al., “Controllable photon energy deposition efficiency in laser processing of fused silica by temporally shaped femtosecond pulse: Experimental and theoretical study”, Optics and Laser Technology, 128 (2020): 106265) and (Jiang, Lan, et al., “High-throughput rear-surface drilling of microchannels in glass based on electron dynamics control using femtosecond pulse trains”, (2012): 2781).

### SUMMARY

In the technique for shaping a light pulse for laser processing using an SLM as described above, energy loss occurs in the light pulse during shaping. Therefore, in order to improve the energy utilization efficiency in laser processing, it is desirable that the efficiency of generating the shaped light pulse is high.

Therefore, an object of a data generation device, a data generation method, and a non-transitory storage medium according to one aspect of the present disclosure is to improve the efficiency of generating light pulses, which are shaped using an SLM, for laser processing.

The present disclosure is summarized as follows.

A data generation device for generating data to control a spatial light modulator for shaping a light pulse for laser processing comprising at least one processor configured to: set information regarding a plurality of mutually different temporal-intensity waveforms each including a plurality of light pulses; generate each of a plurality of sets of an intensity spectrum function and a phase spectrum function based on each of the plurality of temporal-intensity waveforms; generate each of a plurality of pieces of data based on each of the plurality of sets of the intensity spectrum function and the phase spectrum function; and calculate a generation efficiency in the spatial light modulator for each of the plurality of temporal-intensity waveforms based on each of the plurality of pieces of data and determine data for controlling the spatial light modulator from among the plurality of pieces of data based on the generation efficiency.

According to the data generation device, the data generation method, and the non-transitory storage medium according to one aspect of the present disclosure, it is possible to improve the efficiency of generating light pulses, which are shaped using an SLM, for laser processing.

The present invention will be more fully understood from the detailed description given herein below and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a diagram schematically showing the configuration of a data generation device according to an embodiment of the present disclosure.

FIG. 2 is a diagram showing the configuration of an optical system included in a light control device.

FIG. 3 is a diagram showing the modulation surface of an SLM.

FIG. 4A is a diagram showing, as an example, a spectral waveform (spectral phase and spectral intensity) of single-pulsed input light.

FIG. 4B is a diagram showing a temporal-intensity waveform of the input light.

FIG. 5A is a diagram showing, as an example, a spectral waveform (spectral phase and spectral intensity) of output light when an SLM performs rectangular wave-shaped phase spectrum modulation.

FIG. 5B is a diagram showing a temporal-intensity waveform of output light.

FIG. 6 is a diagram schematically showing an example of the hardware configuration of the data generation device.

FIG. 7A is a diagram showing an example of a temporal-intensity waveform set by a waveform setting unit.

FIG. 7B is a diagram showing an example of a temporal-intensity waveform set by the waveform setting unit.

FIG. 7C is a diagram showing an example of a temporal-intensity waveform set by the waveform setting unit.

FIG. 8 shows a procedure for calculating a phase spectrum using an iterative Fourier method as an example.

FIG. 9 is a flowchart showing a data generation method.

FIG. 10 is a diagram showing, for each number of pulses, the generation efficiency in the SLM corresponding to the temporal-intensity waveform set by the waveform setting unit.

FIG. 11A is a diagram showing a spectral waveform corresponding to data point P1 when the number of pulses is nine in FIG. 10.

FIG. 11B is a diagram showing a temporal-intensity waveform corresponding to the spectral waveform.

FIG. 12A is a diagram showing a spectral waveform corresponding to data point P2 when the number of pulses is nine in FIG. 10.

FIG. 12B is a diagram showing a temporal-intensity waveform corresponding to the spectral waveform.

FIG. 13A is a diagram showing a spectral waveform of output light as another example.

FIG. 13B is a diagram showing a temporal-intensity waveform corresponding to the spectral waveform.

FIG. 14A is a diagram showing a spectral waveform of output light as another example.

FIG. 14B is a diagram showing a temporal-intensity waveform corresponding to the spectral waveform.

### DETAILED DESCRIPTION

Hereinafter, embodiments of a data generation device, a data generation method, and a data generation program according to one aspect of the present disclosure will be described in detail with reference to the diagrams. In the diagrams, the same elements or corresponding elements may be denoted by the same reference numerals, and repeated description thereof may be omitted.

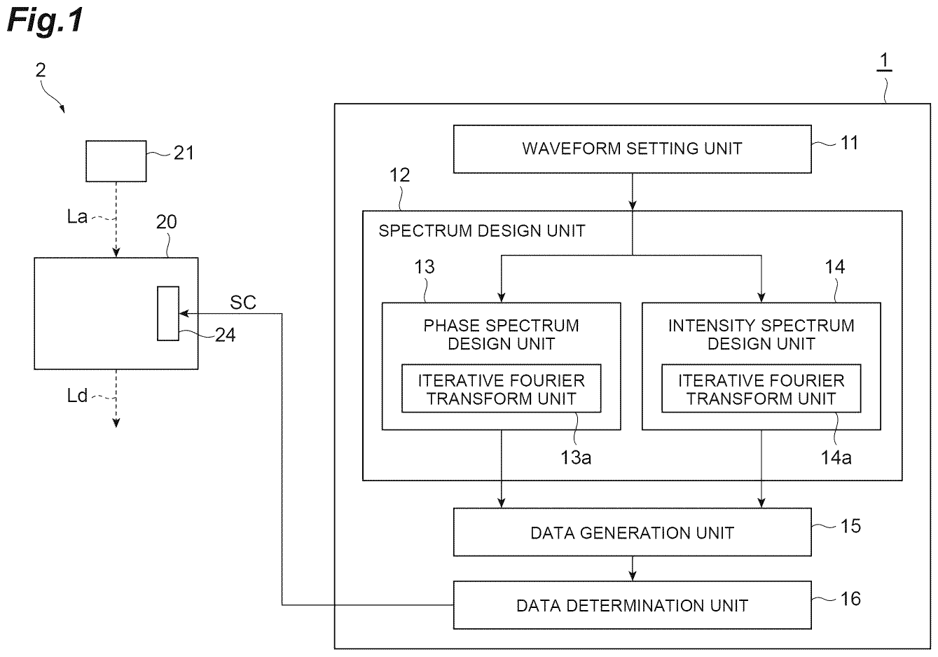

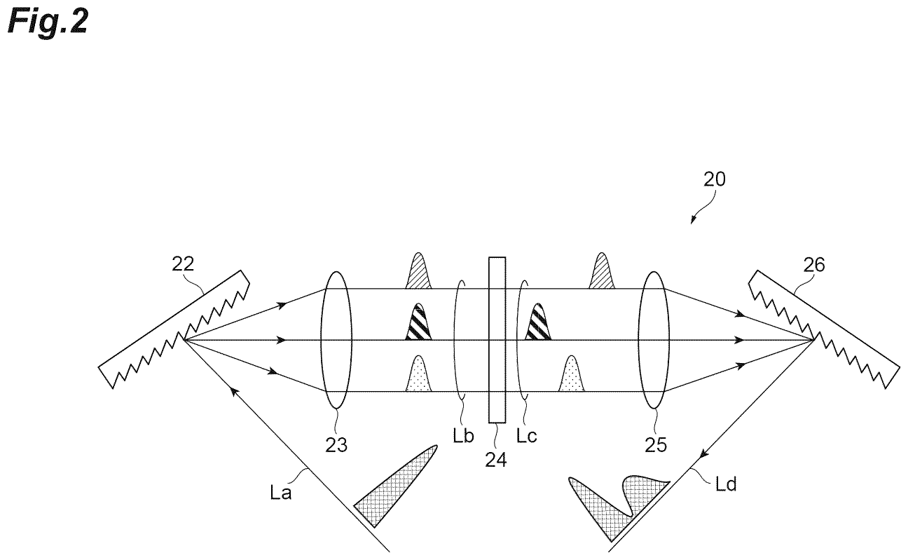

FIG. 1 is a diagram showing the schematic configuration of a data generation device 1 according to an embodiment of the present disclosure. FIG. 2 is a diagram showing the configuration of an optical system 20 provided in a light control device 2. The data generation device 1 forms, for example, a part of the light control device 2. As shown in FIG. 1, the data generation device 1 includes a waveform setting unit 11, a spectrum design unit 12, a data generation unit 15, and a data determination unit 16. The light control device 2 includes the optical system 20 and a light source 21. As shown in FIG. 2, the optical system 20 includes a diffraction grating 22, a lens 23, an SLM 24, a lens 25, and a diffraction grating 26. The light control device 2 generates output light Ld including a plurality of light pulses from input light La, which is a single light pulse. The data generation device 1 generates data for the light control device 2 to generate the output light Ld from the input light La. The output light Ld is used for laser processing.

The light source 21 outputs the input light La that is input to the optical system 20. The light source 21 is, for example, a laser light source such as a solid-state laser light source, a gas laser light source, a liquid laser light source, a semiconductor laser light source, or a fiber laser light source, and the input light La is, for example, coherent pulsed light. The optical system 20 has the SLM 24, and the SLM 24 receives a control signal SC for controlling each pixel of the SLM 24 from the data generation device 1. The optical system 20 converts the input light La from the light source 21 into the output light Ld. The control signal SC includes a modulation pattern of the SLM 24 that converts the input light La into the output light Ld. The modulation pattern is represented by data for controlling the SLM 24, and is data indicating the intensity of a complex amplitude distribution or the intensity of a phase distribution that is output as a file. The modulation pattern is, for example, a computer-generated hologram (CGH).

The diffraction grating 22 is a spectral element in the present embodiment, and is optically coupled to the light source 21. The SLM 24 is optically coupled to the diffraction grating 22 through the lens 23. The diffraction grating 22 disperses the input light La into individual wavelength components. As a spectral element, other optical components such as a prism may be used instead of the diffraction grating 22. The spectral element may be of a reflective type or a transmissive type. The input light La is incident obliquely on the diffraction grating 22 and is dispersed into a plurality of wavelength components. Light Lb including the plurality of wavelength components is focused for each wavelength component by the lens 23, so that an image is formed on the modulation surface of the SLM 24. The lens 23 may be a convex lens formed of a light transmissive member, or may be a concave mirror having a concave light reflecting surface.

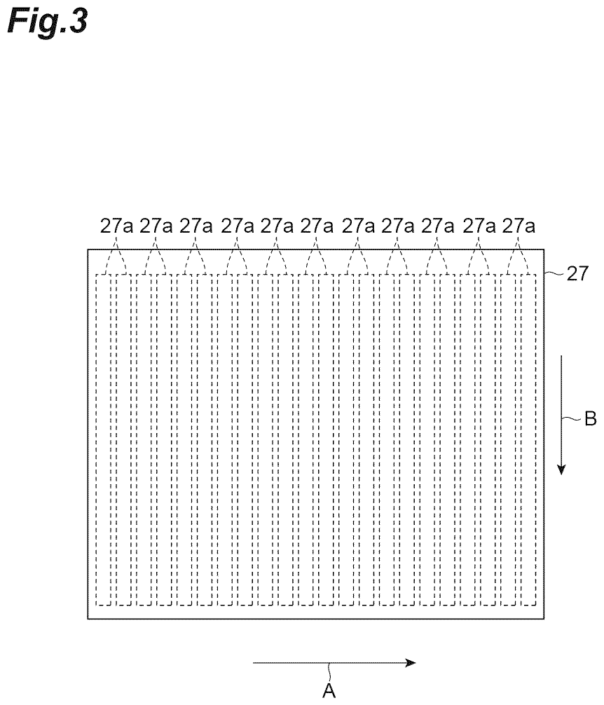

The SLM 24 simultaneously performs phase modulation and intensity modulation of the light Lb to generate the output light Ld including a plurality of light pulses by shaping the input light La, which is a single light pulse. The SLM 24 may perform only the intensity modulation. The SLM 24 is, for example, of a phase modulation type. In a practical example, the SLM 24 is of a liquid crystal on silicon (LCOS) type. Alternatively, the SLM 24 may be an intensity modulation type SLM, such as a digital micromirror device (DMD). The SLM 24 may be of a reflective type or a transmissive type. FIG. 3 is a diagram showing a modulation surface 27 of the SLM 24. As shown in FIG. 3, on the modulation surface 27, a plurality of modulation regions 27a are arranged along a certain direction A, and each modulation region 27a extends in a direction B crossing the direction A. The direction A is a spectral dispersion direction by the diffraction grating 22. The modulation surface 27 functions as a Fourier transform surface, and each corresponding wavelength component after dispersing is incident on each of the plurality of modulation regions 27a. The SLM 24 modulates the phase and intensity of each incident wavelength component independently of other wavelength components in each modulation region 27a. Since the SLM 24 in the present embodiment is of the phase modulation type, the intensity modulation is realized by the phase pattern (phase image) presented on the modulation surface 27.

Each wavelength component of modulated light Lc modulated by the SLM 24 is focused at one point on the diffraction grating 26 by the lens 25. The lens 25 at this time functions as a focusing optical system that focuses the modulated light Lc. The lens 25 may be a convex lens formed of a light transmissive member, or may be a concave mirror having a concave light reflecting surface. The diffraction grating 26 functions as a combining optical system, and combines the modulated wavelength components. That is, a plurality of wavelength components of the modulated light Lc are focused and combined by the lens 25 and the diffraction grating 26 to form the output light Ld.

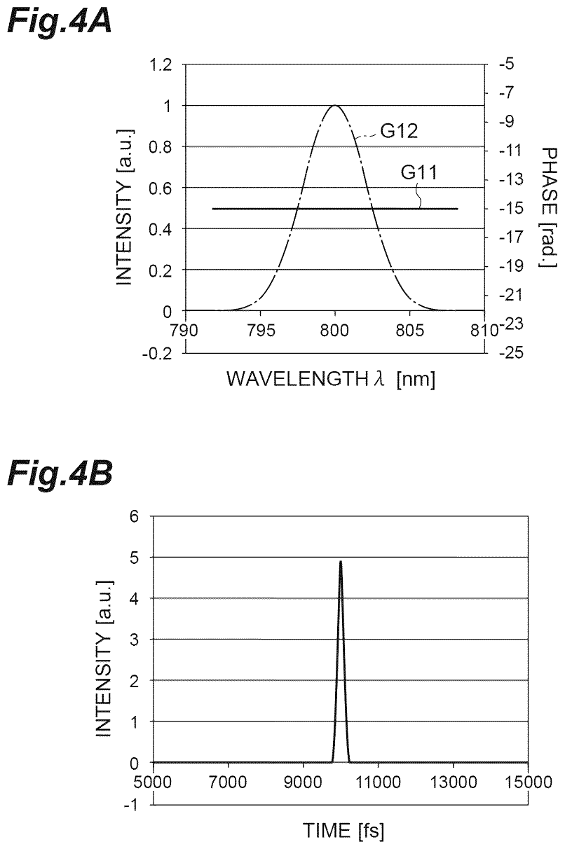

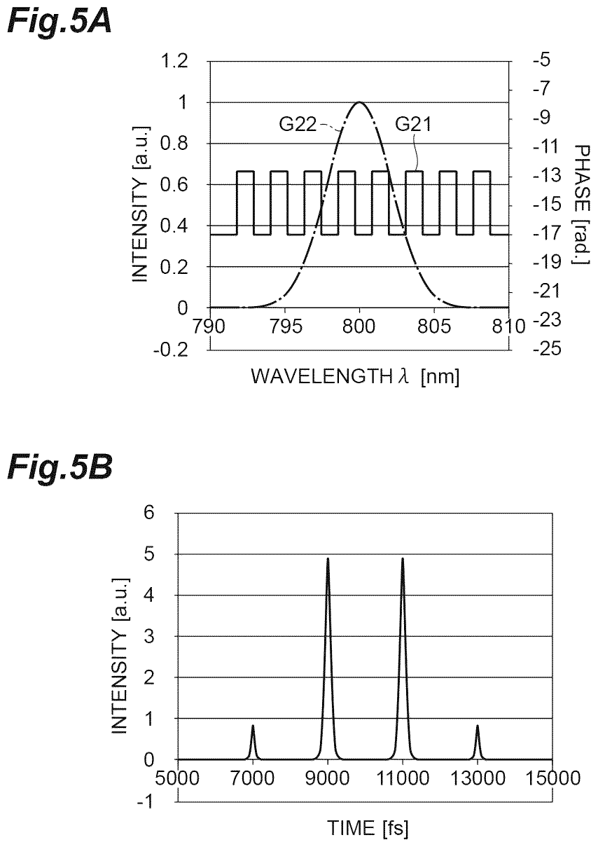

A region in front of the lens 25 (spectral domain) and a region behind the diffraction grating 26 (time domain) have a Fourier transform relationship therebetween. Phase modulation and intensity modulation in the spectral domain affect the temporal-intensity waveform in the time domain. Therefore, the output light Ld has a desired temporal-intensity waveform, which is different from that of the input light La, according to the modulation pattern of the SLM 24. Here, FIG. 4A shows a spectral waveform (spectral phase G11 and spectral intensity G12) of the single-pulsed input light La as an example, and FIG. 4B shows a temporal-intensity waveform of the input light La. FIG. 5A shows, as an example, a spectral waveform (spectral phase G21 and spectral intensity G22) of the output light Ld when the SLM 24 performs rectangular wave-shaped phase spectrum modulation, and FIG. 5B shows a temporal-intensity waveform of the output light Ld. In FIGS. 4A and 5A, the horizontal axis indicates wavelength (nm), the left vertical axis indicates the intensity value (arbitrary unit) of the intensity spectrum, and the right vertical axis indicates the phase value (rad) of the phase spectrum. In FIGS. 4B and 5B, the horizontal axis indicates time (femtoseconds), and the vertical axis indicates light intensity (arbitrary unit). In this example, a single pulse of the input light La is converted into a double pulse with higher-order light as the output light Ld by applying a rectangular wave-shaped phase spectrum waveform to the output light Ld. The spectra and waveforms shown in FIGS. 4A to 5B are examples, and the temporal-intensity waveform of the output light Ld can be shaped into various shapes by combining various phase spectra and intensity spectra.

FIG. 1 is referred to again. The data generation device 1 is, for example, a personal computer, a smart device such as a smartphone or a tablet terminal, or a computer having a processor such as a cloud server. The data generation device 1 is electrically connected to the SLM 24, and calculates a phase modulation pattern for approximating the temporal-intensity waveform of the output light Ld to a desired waveform and provides the SLM 24 with the control signal SC including the phase modulation pattern. The data generation device 1 according to the present embodiment presents phase patterns including a phase pattern for phase modulation, which is for applying a phase spectrum for obtaining a desired waveform to the output light Ld, and a phase pattern for intensity modulation, which is for applying an intensity spectrum for obtaining a desired waveform to the output light Ld, to the SLM 24. For this purpose, the data generation device 1 includes the waveform setting unit 11, the spectrum design unit 12, the data generation unit 15, and the data determination unit 16. The spectrum design unit 12 includes a phase spectrum design unit 13 and an intensity spectrum design unit 14. That is, a processor of a computer provided in the data generation device 1 realizes the function of the waveform setting unit 11, the function of the phase spectrum design unit 13, the function of the intensity spectrum design unit 14, the function of the data generation unit 15, and the function of the data determination unit 16. The respective functions may be realized by the same processor or by different processors.

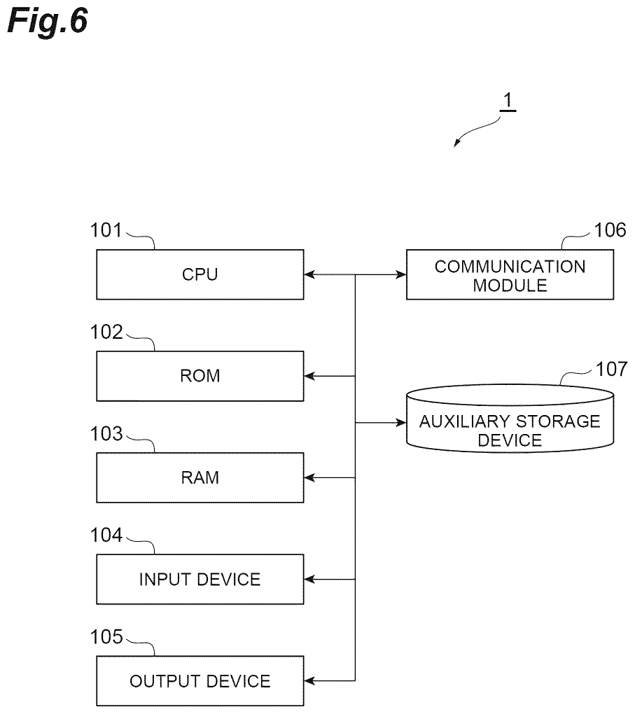

FIG. 6 is a diagram showing an example of the hardware configuration of the data generation device 1. As shown in FIG. 6, the data generation device 1 can physically be a normal computer including a processor (CPU) 101, a main storage device such as a ROM 102 and a RAM 103, an input device 104 such as a keyboard, a mouse, and a touch screen, an output device 105 such as a display (including a touch screen), a communication module 106 such as a network card for transmitting and receiving data to and from other devices, and an auxiliary storage device 107 such as a hard disk.

The processor 101 of the computer can realize the above-described functions (the waveform setting unit 11, the phase spectrum design unit 13, the intensity spectrum design unit 14, the data generation unit 15, and the data determination unit 16) by using a data generation program. Therefore, the data generation program causes the processor 101 of the computer to operate as the waveform setting unit 11, the phase spectrum design unit 13, the intensity spectrum design unit 14, the data generation unit 15, and the data determination unit 16 in the data generation device 1. The data generation program is stored in a storage device (storage medium) inside or outside the computer, such as the auxiliary storage device 107. The storage device may be a non-transitory storage medium. Examples of recording media include a recording medium such as a flexible disk, a CD, or a DVD, a recording medium such as a ROM, a semiconductor memory, and a cloud server.

The waveform setting unit 11 receives input of information regarding a desired temporal-intensity waveform of the output light Ld. The information regarding a desired temporal-intensity waveform includes setting conditions such as pulse width, the number of pulses, and a pulse interval. Based on the information regarding a desired temporal-intensity waveform, the waveform setting unit 11 randomly sets, as the desired temporal-intensity waveform, each of a plurality of mutually different temporal-intensity waveforms that satisfy the setting conditions and each include a plurality of light pulses. Alternatively, in response to input from the operator, the waveform setting unit 11 may set, as the desired temporal-intensity waveform, each of a plurality of mutually different temporal-intensity waveforms that satisfy the setting conditions and each include a plurality of light pulses.

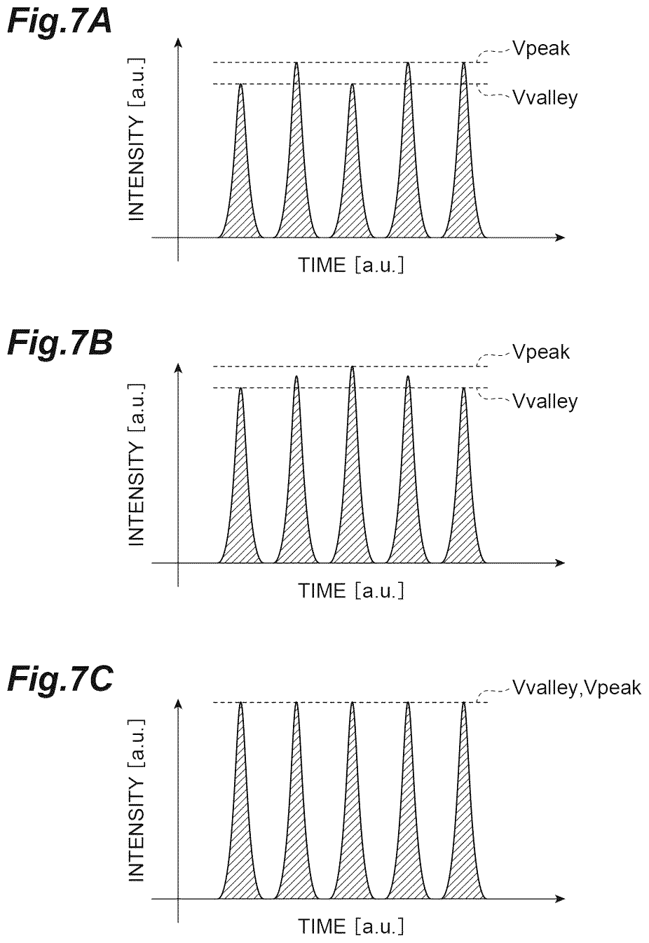

FIGS. 7A, 7B, and 7C each show an example of the temporal-intensity waveform set by the waveform setting unit 11. In FIGS. 7A, 7B, and 7C, the horizontal axis indicates time (arbitrary unit), and the vertical axis indicates light intensity (arbitrary unit). The temporal-intensity waveforms shown in FIGS. 7A, 7B, and 7C are examples of a randomly set temporal-intensity waveform that includes five light pulses and has a minimum peak value V_{valley} that is 80% or more of the maximum peak value Vₚₑₐₖ. As shown in FIGS. 7A and 7B, a plurality of mutually different temporal-intensity waveforms with different peak values of a plurality of light pulses are set. As shown in FIG. 7C, the minimum peak value V_{valley} and the maximum peak value Vₚₑₐₖ may be equal (that is, the peak values of a plurality of pulses included in the temporal-intensity waveform may be uniform). The lower limit of the minimum peak value V_{valley} is not limited to 80% of the maximum peak value Vₚₑₐₖ. The minimum peak value V_{valley} may be, for example, 80% or more and 95% or less of the maximum peak value Vₚₑₐₖ. The upper limit of the minimum peak value V_{valley} is not limited to 95% of the maximum peak value Vₚₑₐₖ. There may be one or more pulses with the minimum peak value V_{valley} and one or more pulses having the maximum peak value Vₚₑₐₖ. The number of pulses included in the temporal-intensity waveform is not limited to five, and may be, for example, 50 or fewer or 20 or fewer. The pulse interval between a plurality of light pulses included in the temporal-intensity waveform may be, for example, 10 fs or more and 100 ps or less. FIGS. 7A, 7B, and 7C each show an example of a case where the pulse interval is constant.

The information regarding a desired temporal-intensity waveform is provided to the phase spectrum design unit 13 and the intensity spectrum design unit 14. The phase spectrum design unit 13 calculates a phase spectrum of the output light Ld suitable for realizing a provided desired temporal-intensity waveform. The intensity spectrum design unit 14 calculates an intensity spectrum of the output light Ld suitable for realizing a provided desired temporal-intensity waveform. The data generation unit 15 calculates a phase modulation pattern (for example, a computer-generated hologram) for applying the phase spectrum obtained by the phase spectrum design unit 13 and the intensity spectrum obtained by the intensity spectrum design unit 14 to the output light Ld. Then, the control signal SC including the calculated phase modulation pattern is provided to the SLM 24, and the SLM 24 is controlled based on the control signal SC.

Here, a method for calculating the phase spectrum and the intensity spectrum corresponding to a desired temporal-intensity waveform will be described in detail. The desired temporal-intensity waveform is expressed as a function in the time domain, and the phase spectrum and the intensity spectrum are expressed as functions in the frequency domain. Therefore, the phase spectrum and the intensity spectrum corresponding to the desired temporal-intensity waveform are obtained by iterative Fourier transform based on the desired temporal-intensity waveform. In the method described below, the phase spectrum and the intensity spectrum are calculated using an iterative Fourier transform method. Therefore, as shown in FIG. 1, the phase spectrum design unit 13 has an iterative Fourier transform unit 13a, and the intensity spectrum design unit 14 has an iterative Fourier transform unit 14a.

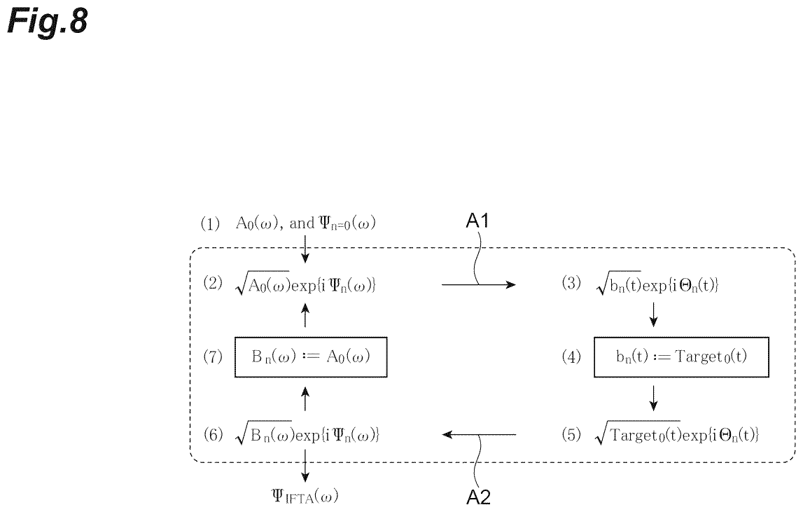

FIG. 8 shows a procedure for calculating a phase spectrum using an iterative Fourier method as an example in the iterative Fourier transform unit 13a. First, initial intensity spectrum function A₀(ω) and phase spectrum function Ψₙ₌₀(ω), which are functions of a frequency ω, are prepared (process number (1) in the diagram). In one example, the intensity spectrum function A₀(ω) and phase spectrum function Ψₙ₌₀(ω) indicate the intensity spectrum and the phase spectrum of the input light La, respectively. Then, a waveform function (a) in the frequency domain including the intensity spectrum function A₀(ω) and the phase spectrum function Ψₙ(ω) is prepared (process number (2) in the diagram).

$$[ Equation 1 ]$$

$$\sqrt{{A}_{0} ( ω )} exp \{ i {Ψ}_{n} ( ω ) \} \qquad ( a )$$

The subscript n indicates the result after the n-th Fourier transform process. Before the first Fourier transform process, the above-described initial phase spectrum function Ψₙ₌₀(ω) is used as the phase spectrum function Ψₙ(ω). i is an imaginary number.

Subsequently, the above function (a) is subjected to Fourier transform from the frequency domain to the time domain (arrow A1 in the diagram). As a result, a time function (b) in the time domain including a temporal-intensity waveform function bₙ(t) is obtained (process number (3) in the diagram).

$$[ Equation 2 ]$$

$$\sqrt{{b}_{n} ( t )} exp \{ i {Θ}_{n} ( t ) \} \qquad ( b )$$

Subsequently, the temporal-intensity waveform function bₙ(t) included in the above function (b) is replaced with Target₀(t) based on a desired waveform (process numbers (4) and (5) in the diagram).

$$[ Equation 3 ]$$

$${b}_{n} ( t ) := {Target}_{0} ( t ) \qquad ( c )$$

$$[ Equation 4 ]$$

$$\sqrt{{Target}_{0} ( t )} exp \{ i {Θ}_{n} ( t ) \} \qquad ( d )$$

Subsequently, the above function (d) is subjected to inverse Fourier transform from the time domain to the frequency domain (arrow A2 in the diagram). As a result, a waveform function (e) in the frequency domain including an intensity spectrum function Bₙ(ω) and a phase spectrum function Ψₙ(ω) is obtained (process number (6) in the diagram).

$$[ Equation 5 ]$$

$$\sqrt{{B}_{n} ( ω )} exp \{ i {Ψ}_{n} ( ω ) \} \qquad ( e )$$

Subsequently, in order to constrain the intensity spectrum function Bₙ(ω) included in the above function (e), the intensity spectrum function Bₙ(ω) is replaced with the initial intensity spectrum function A₀(ω) (process number (7) in the diagram).

$$[ Equation 6 ]$$

$${B}_{n} ( ω ) := {A}_{0} ( ω ) \qquad ( f )$$

Thereafter, by repeating the above processes (1) to (7) multiple times, the phase spectrum shape represented by the phase spectrum function Ψₙ(ω) in the waveform function can be made to approximate the phase spectrum shape corresponding to the desired temporal-intensity waveform. A finally obtained phase spectrum function Ψ_{IFTA}(ω) is used to calculate the modulation pattern.

The above-described procedure for calculating the phase spectrum is used to calculate the phase spectrum corresponding to each of the plurality of temporal-intensity waveforms set by the waveform setting unit 11. The above-described iterative Fourier method as an example can be used for the iterative Fourier transform unit 14a to calculate not only the phase spectrum but also the intensity spectrum corresponding to each of the plurality of temporal-intensity waveforms set by the waveform setting unit 11. The method for calculating the phase spectrum and the intensity spectrum is not limited to the above-described iterative Fourier method as an example, but may be an iterative Fourier method including a different calculation procedure.

The data determination unit 16 is provided with a plurality of pieces of data indicating a plurality of modulation patterns calculated by the data generation unit 15. The data determination unit 16 calculates a generation efficiency in the SLM 24 corresponding to each of the plurality of temporal-intensity waveforms set by the waveform setting unit 11, based on the plurality of pieces of data respectively corresponding to the plurality of temporal-intensity waveforms, and determines data for controlling the SLM 24 based on the generation efficiency. The data determination unit 16 determines, for example, data indicating a modulation pattern with the highest generation efficiency as data for controlling the SLM 24. The generation efficiency is a value obtained by dividing the energy of the output light Ld by the energy of the input light La.

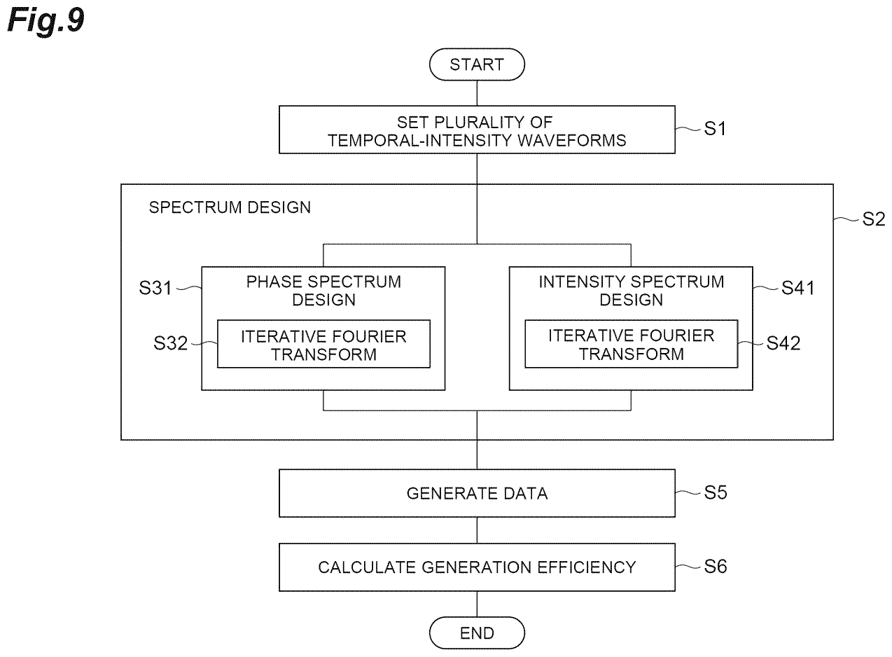

FIG. 9 is a flowchart showing a data generation method realized by the data generation device 1 described above. The data generation program described above causes the processor 101 (see FIG. 6) of the computer to execute each step included in this flowchart. As shown in FIG. 9, first, the waveform setting unit 11 sets a plurality of temporal-intensity waveforms based on information regarding a desired temporal-intensity waveform that has been received as an input (waveform setting step S1). Then, the phase spectrum design unit and the intensity spectrum design unit calculate a phase spectrum and an intensity spectrum for approximating the temporal-intensity waveform to each of the plurality of temporal-intensity waveforms set by the waveform setting unit 11 (spectrum design step S2).

The spectrum design step S2 includes a phase spectrum design step S31 and an intensity spectrum design step S41. The phase spectrum design step S31 includes an iterative Fourier transform step S32 by the iterative Fourier transform unit 13a. The details of the iterative Fourier transform step S32 are similar to the operation of the iterative Fourier transform unit 13a described above. The finally obtained phase spectrum function Ψ_{IFTA}(ω) is provided for the subsequent data generation step S5. The intensity spectrum design step S41 includes an iterative Fourier transform step S42 by the iterative Fourier transform unit 14a. The details of the iterative Fourier transform step S42 are similar to the operation of the iterative Fourier transform unit 14a. The finally obtained intensity spectrum function A_{IFTA}(ω) is provided for the subsequent data generation step S5.

In the data generation step S5, a modulation pattern is calculated based on the phase spectrum function Ψ_{IFTA}(ω) and the intensity spectrum function A_{IFTA}(ω). In the data generation step S5, a plurality of modulation patterns respectively corresponding to a plurality of temporal-intensity waveforms set by the waveform setting unit 11 are calculated. The plurality of modulation patterns are provided for a data determination step S6.

In the data determination step S6, a generation efficiency in the SLM 24 for each of the plurality of temporal-intensity waveforms respectively corresponding to the plurality of modulation patterns is calculated based on each of the plurality of modulation patterns, and a modulation pattern to be presented to the SLM 24 is determined based on the generation efficiency.

The effects obtained by the data generation device 1, the data generation method, and the data generation program according to the present embodiment described above will be described.

In the data generation device 1, the data generation method, and the data generation program, a plurality of pieces of data are generated based on a plurality of mutually different temporal-intensity waveforms each including a plurality of light pulses with varying peak values, and data for controlling the SLM 24 is determined based on the efficiency of generating each temporal-intensity waveform corresponding to each piece of data from among the plurality of generated pieces of data in the spatial light modulator. This makes it possible to shape the light pulses so as to approximate the temporal-intensity waveform corresponding to the desired generation efficiency. Therefore, it is possible to improve the efficiency of generating light pulses for laser processing.

The data determination unit 16 may determine, from among the plurality of pieces of data, data for controlling the SLM 24 that has the highest generation efficiency. This makes it possible to shape the light pulses so as to approximate the temporal-intensity waveform with the highest generation efficiency. Therefore, it is possible to further improve the efficiency of generating light pulses for laser processing.

The minimum peak value of the plurality of light pulses may be 80% or more of the maximum peak value of the plurality of light pulses. This improves the accuracy of calculating the intensity spectrum function and the phase spectrum function for approximating the temporal-intensity waveform set by the waveform setting unit 11. In addition, it is possible to obtain processing results that are almost the same as when the peak values are uniform.

The minimum peak value may be 80% or more and 95% or less of the maximum peak value. By setting the minimum peak value to 80% or more of the maximum peak value, the accuracy of calculating the intensity spectrum function and the phase spectrum function for approximating the temporal-intensity waveform set by the waveform setting unit 11 is improved. In addition, it is possible to obtain processing results that are almost the same as when the peak values are uniform. By setting the minimum peak value to 95% or less of the maximum peak value, the waveform setting unit 11 can set a temporal-intensity waveform in which the peak values of the plurality of light pulses vary more greatly. Therefore, since the possibility of shaping the light pulses so as to approximate a temporal-intensity waveform with higher generation efficiency increases, it is possible to further improve the efficiency of generating the light pulses for laser processing.

The waveform setting unit 11 may set information regarding a temporal-intensity waveform including 50 or fewer light pulses. This makes it possible to shape the light pulses so as to approximate the temporal-intensity waveform suitable for laser processing. The waveform setting unit 11 may set information regarding a temporal-intensity waveform including 50 or fewer light pulses, for example, when the number of pulses has a greater effect on the processing result than the generation efficiency and the uniformity of peak values.

The waveform setting unit 11 may set information regarding a temporal-intensity waveform including 20 or fewer light pulses. This makes it possible to shape the light pulses so as to approximate the temporal-intensity waveform suitable for laser processing. The waveform setting unit 11 may set information regarding a temporal-intensity waveform including 20 or fewer light pulses, for example, when the generation efficiency and the uniformity of peak values have a greater effect on the processing result than the number of pulses.

The waveform setting unit 11 may set information regarding a temporal-intensity waveform including a plurality of light pulses with pulse intervals of 10 fs or more and 100 ps or less. This makes it possible to shape the light pulses so as to approximate the temporal-intensity waveform suitable for laser processing.

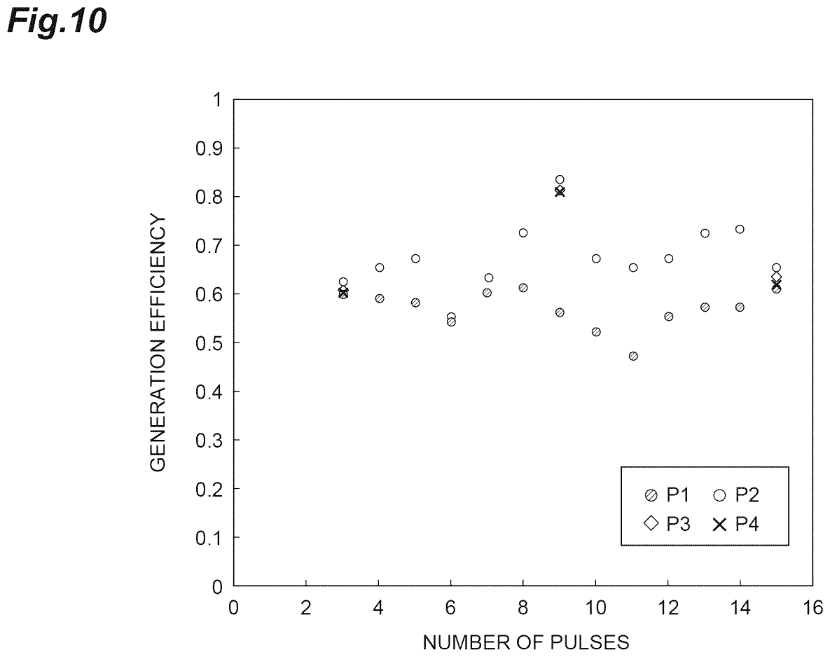

FIG. 10 is a diagram showing, for each number of pulses, the generation efficiency in the SLM 24 corresponding to the temporal-intensity waveform set by the waveform setting unit 11. Data point P1 is a generation efficiency when the peak values of a plurality of pulses included in the temporal-intensity waveform are uniform. Data point P2 is a generation efficiency when the minimum peak value V_{valley} of the plurality of pulses included in the temporal-intensity waveform is 80% of the maximum peak value Vₚₑₐₖ. Data point P3 is a generation efficiency when the minimum peak value V_{valley} of the plurality of pulses included in the temporal-intensity waveform is 90% of the maximum peak value Vₚₑₐₖ. Data point P4 is a generation efficiency when the minimum peak value V_{valley} of the plurality of pulses included in the temporal-intensity waveform is 95% of the maximum peak value Vₚₑₐₖ. The conditions for setting each data point are a central wavelength of 800 nm, a spectral width of 10 nm, and a pulse interval of 0.5 ps. Each data point indicates the highest generation efficiency after calculating the generation efficiency in the SLM 24 corresponding to each of a plurality of mutually different temporal-intensity waveforms set by the waveform setting unit 11, each of which includes a plurality of light pulses. Therefore, it has been confirmed that among the plurality of temporal-intensity waveforms, there is a temporal-intensity waveform with the improved generation efficiency compared to a case where a temporal-intensity waveform in which the peak values of a plurality of pulses are uniform is set.

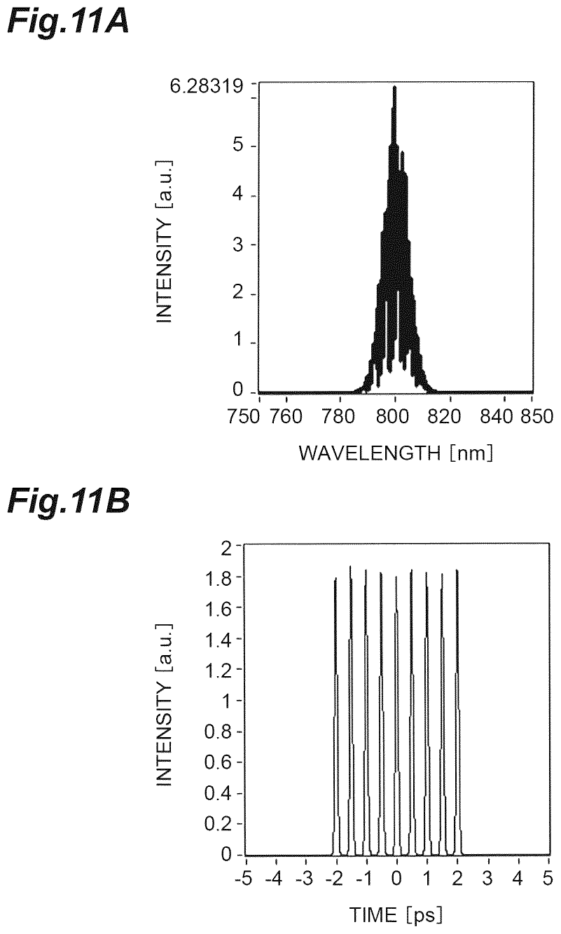

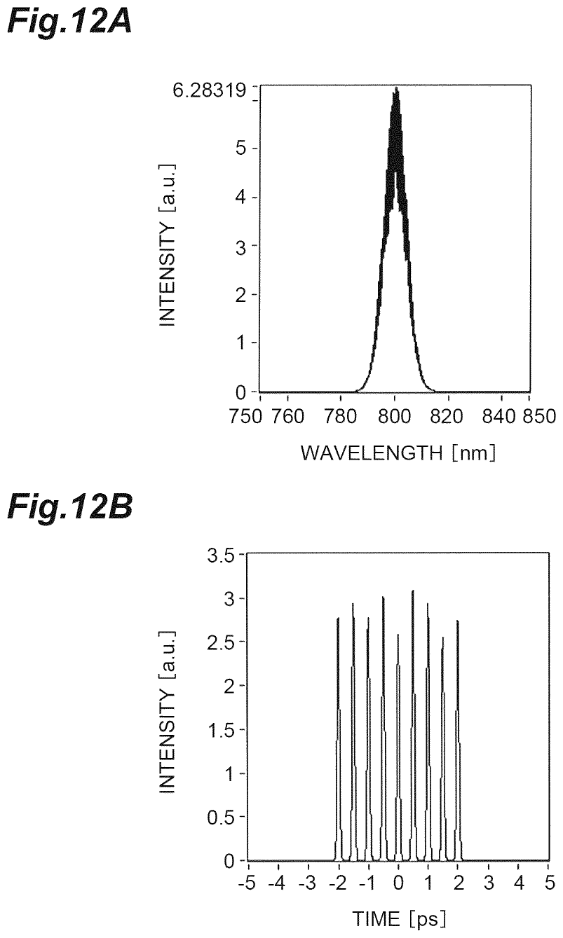

FIG. 11A shows a spectral waveform corresponding to the data point P1 when the number of pulses is nine in FIG. 10, and FIG. 11B shows a temporal-intensity waveform corresponding to the spectral waveform. FIG. 12A shows a spectral waveform corresponding to data point P2 when the number of pulses is nine in FIG. 10, and FIG. 12B shows a temporal-intensity waveform corresponding to the spectral waveform. In FIGS. 11A and 12A, the horizontal axis indicates wavelength (nm), and the vertical axis indicates the intensity value (arbitrary unit) of the intensity spectrum. In FIGS. 11B and 12B, the horizontal axis indicates time (ps) and the vertical axis indicates light intensity (arbitrary unit). The generation efficiency in the SLM 24 corresponding to the temporal-intensity waveform shown in FIG. 11B is 56%. The generation efficiency in the SLM 24 corresponding to the temporal-intensity waveform shown in FIG. 12B is 83%. Therefore, it has been confirmed that among the plurality of mutually different temporal-intensity waveforms each including a plurality of light pulses, there is a temporal-intensity waveform with the higher generation efficiency in the SLM 24 compared to a temporal-intensity waveform including a plurality of light pulses with uniform peak values.

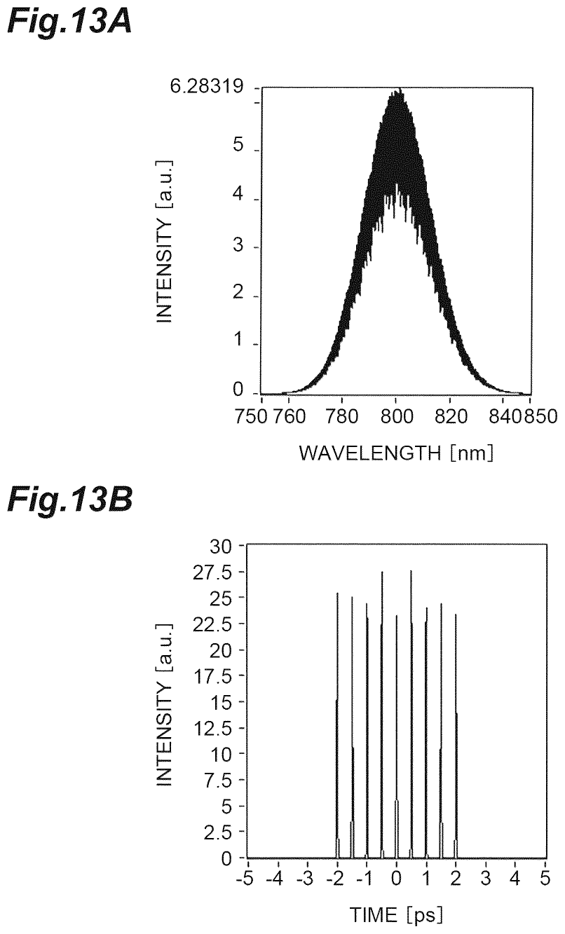

FIG. 13A shows a spectral waveform of the output light Ld as another example, and FIG. 13B shows a temporal-intensity waveform corresponding to the spectral waveform. In FIG. 13A, the horizontal axis indicates wavelength (nm), and the vertical axis indicates the intensity value (arbitrary unit) of the intensity spectrum. In FIG. 13B, the horizontal axis indicates time (ps) and the vertical axis indicates light intensity (arbitrary unit). The setting conditions are a central wavelength of 800 nm, a spectral width of 30 nm, and a pulse interval of 0.5 ps. The generation efficiency in the SLM 24 corresponding to the temporal-intensity waveform shown in FIG. 13B is 82%. The generation efficiency in the SLM 24 corresponding to a temporal-intensity waveform including a plurality of light pulses with uniform peak values is 56%. Therefore, an improvement in generation efficiency has been confirmed.

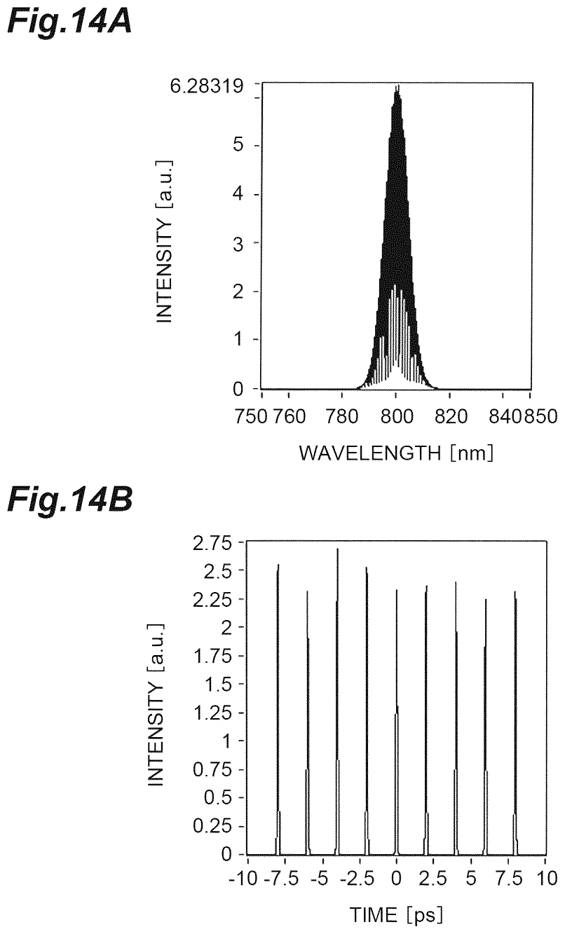

FIG. 14A shows a spectral waveform of the output light Ld as another example, and FIG. 14B shows a temporal-intensity waveform corresponding to the spectral waveform. In FIG. 14A, the horizontal axis indicates wavelength (nm), and the vertical axis indicates the intensity value (arbitrary unit) of the intensity spectrum. In FIG. 14B, the horizontal axis indicates time (ps) and the vertical axis indicates light intensity (arbitrary unit). The setting conditions are a central wavelength of 800 nm, a spectral width of 10 nm, and a pulse interval of 2 ps. The generation efficiency in the SLM 24 corresponding to the temporal-intensity waveform shown in FIG. 14B is 73%. The generation efficiency in the SLM 24 corresponding to a temporal-intensity waveform including a plurality of light pulses with uniform peak values is 64%. Therefore, an improvement in generation efficiency has been confirmed.

The data generation device, the data generation method, and the data generation program according to the present disclosure are expressed as follows.
(1) A data generation device for generating data to control a spatial light modulator for shaping a light pulse for laser processing, the device comprising at least one processor configured to: set information regarding a plurality of mutually different temporal-intensity waveforms each including a plurality of light pulses; generate each of a plurality of sets of an intensity spectrum function and a phase spectrum function based on each of the plurality of temporal-intensity waveforms; generate each of a plurality of pieces of data based on each of the plurality of sets of the intensity spectrum function and the phase spectrum function; and calculate a generation efficiency in the spatial light modulator for each of the plurality of temporal-intensity waveforms based on each of the plurality of pieces of data and determine data for controlling the spatial light modulator from among the plurality of pieces of data based on the generation efficiency.

The present inventors' research has revealed the following phenomena. When a single pulse is shaped into a plurality of light pulses with uniform peak values by a spatial light modulator and the plurality of light pulses are used for laser processing, the processing results using the same temporal-intensity waveform have low reproducibility and tend to vary depending on the number of light pulses. Therefore, the present inventors have obtained the following findings through further research. That is, among a plurality of mutually different temporal-intensity waveforms each including a plurality of light pulses, each of which has a variation in the peak values of the plurality of light pulses, there is a temporal-intensity waveform with the higher generation efficiency in the spatial light modulator compared to a temporal-intensity waveform including a plurality of light pulses with uniform peak values. In the data generation device described above, a plurality of pieces of data are generated based on a plurality of mutually different temporal-intensity waveforms, and data for controlling the spatial light modulator is determined, based on the generation efficiency in the spatial light modulator for each temporal-intensity waveform corresponding to each piece of data, from among the plurality of generated pieces of data. This makes it possible to shape the light pulses so as to approximate the temporal-intensity waveform corresponding to the desired generation efficiency. Therefore, it is possible to improve the efficiency of generating light pulses for laser processing.
(2) The data generation device according to (1), wherein the at least one processor is configured to determine, from among the plurality of pieces of data, data for controlling the spatial light modulator having the highest generation efficiency when determining the data. This makes it possible to shape the light pulses so as to approximate the temporal-intensity waveform with the highest generation efficiency. Therefore, it is possible to further improve the efficiency of generating light pulses for laser processing.
(3) The data generation device according to (1) or (2), wherein a minimum peak value of the plurality of light pulses is 80% or more of a maximum peak value of the plurality of light pulses. This improves the accuracy of calculating the intensity spectrum function and the phase spectrum function for approximating the temporal-intensity waveform set by the waveform setting unit. In addition, it is possible to obtain processing results that are almost the same as when the peak values are uniform.
(4) The data generation device according to any one of (1) to (3), wherein the minimum peak value is 80% or more and 95% or less of the maximum peak value. By setting the minimum peak value to 80% or more of the maximum peak value, the accuracy of calculating the intensity spectrum function and the phase spectrum function for approximating the temporal-intensity waveform set by the waveform setting unit is improved. In addition, it is possible to obtain processing results that are almost the same as when the peak values are uniform. By setting the minimum peak value to 95% or less of the maximum peak value, the waveform setting unit can set a temporal-intensity waveform in which the peak values of the plurality of light pulses vary more greatly. Therefore, since the possibility of shaping the light pulses so as to approximate a temporal-intensity waveform with higher generation efficiency increases, it is possible to further improve the efficiency of generating the light pulses for laser processing.
(5) The data generation device according to any one of (1) to (4), wherein the at least one processor is configured to set information regarding the temporal-intensity waveform including 50 or fewer light pulses. This makes it possible to shape the light pulses so as to approximate a temporal-intensity waveform suitable for laser processing.
(6) The data generation device according to any one of (1) to (5), wherein the at least one processor is configured to set information regarding the temporal-intensity waveform including 20 or fewer light pulses when setting the information. This makes it possible to shape the light pulses so as to approximate a temporal-intensity waveform suitable for laser processing.
(7) The data generation device according to any one of (1) to (6), wherein the at least one processor is configured to set information regarding the temporal-intensity waveform including the plurality of light pulses having a pulse interval of 10 fs or more and 100 ps or less when setting the information. This makes it possible to shape the light pulses so as to approximate a temporal-intensity waveform suitable for laser processing.
(8) A data generation method for generating data to control a spatial light modulator for shaping a light pulse for laser processing, the method comprising: setting information regarding a plurality of mutually different temporal-intensity waveforms each including a plurality of light pulses; generating each of a plurality of sets of an intensity spectrum function and a phase spectrum function based on each of the plurality of temporal-intensity waveforms; generating each of a plurality of pieces of data based on each of the plurality of sets of the intensity spectrum function and the phase spectrum function; and calculating a generation efficiency in the spatial light modulator for each of the plurality of temporal-intensity waveforms based on each of the plurality of pieces of data and determining data for controlling the spatial light modulator from among the plurality of pieces of data based on the generation efficiency.
(9) A non-transitory storage medium storing a program for generating data to control a spatial light modulator for shaping a light pulse for laser processing, the program causing a computer to execute: setting information regarding a plurality of mutually different temporal-intensity waveforms each including a plurality of light pulses; generating each of a plurality of sets of an intensity spectrum function and a phase spectrum function based on each of the plurality of temporal-intensity waveforms; generating each of a plurality of pieces of data based on each of the plurality of sets of the intensity spectrum function and the phase spectrum function; and calculating a generation efficiency in the spatial light modulator for each of the plurality of temporal-intensity waveforms based on each of the plurality of pieces of data and determining data for controlling the spatial light modulator from among the plurality of pieces of data based on the generation efficiency.

In this data generation program, a plurality of pieces of data are generated based on a plurality of mutually different temporal-intensity waveforms, and data for controlling the spatial light modulator is determined, based on the generation efficiency in the spatial light modulator for each temporal-intensity waveform corresponding to each piece of data, from among the plurality of generated pieces of data. This makes it possible to shape the light pulse so as to approximate the temporal-intensity waveform corresponding to the desired generation efficiency. Therefore, it is possible to improve the efficiency of generating light pulses for laser processing.

What is claimed is:

1. A data generation device for generating data to control a spatial light modulator for shaping a light pulse for laser processing, the device comprising at least one processor configured to:
set information regarding a plurality of mutually different temporal-intensity waveforms each including a plurality of light pulses;
generate each of a plurality of sets of an intensity spectrum function and a phase spectrum function based on each of the plurality of temporal-intensity waveforms;
generate each of a plurality of pieces of data based on each of the plurality of sets of the intensity spectrum function and the phase spectrum function; and
calculate a generation efficiency in the spatial light modulator for each of the plurality of temporal-intensity waveforms based on each of the plurality of pieces of data and determine data for controlling the spatial light modulator from among the plurality of pieces of data based on the generation efficiency.

2. The data generation device according to claim 1,
wherein the at least one processor is configured to determine, from among the plurality of pieces of data, data for controlling the spatial light modulator having the highest generation efficiency when determining the data.

3. The data generation device according to claim 1,
wherein a minimum peak value of the plurality of light pulses is 80% or more of a maximum peak value of the plurality of light pulses.

4. The data generation device according to claim 3,
wherein the minimum peak value is 80% or more and 95% or less of the maximum peak value.

5. The data generation device according to claim 1,
wherein the at least one processor is configured to set information regarding the temporal-intensity waveform including 50 or fewer light pulses when setting the information.

6. The data generation device according to claim 5,
wherein the at least one processor is configured to set information regarding the temporal-intensity waveform including 20 or fewer light pulses when setting the information.

7. The data generation device according to claim 1,
wherein the at least one processor is configured to set information regarding the temporal-intensity waveform including the plurality of light pulses having a pulse interval of 10 fs or more and 100 ps or less when setting the information.

8. A data generation method for generating data to control a spatial light modulator for shaping a light pulse for laser processing, the method comprising:
setting information regarding a plurality of mutually different temporal-intensity waveforms each including a plurality of light pulses;
generating each of a plurality of sets of an intensity spectrum function and a phase spectrum function based on each of the plurality of temporal-intensity waveforms;
generating each of a plurality of pieces of data based on each of the plurality of sets of the intensity spectrum function and the phase spectrum function; and
calculating a generation efficiency in the spatial light modulator for each of the plurality of temporal-intensity waveforms based on each of the plurality of pieces of data and determining data for controlling the spatial light modulator from among the plurality of pieces of data based on the generation efficiency.

9. A non-transitory storage medium storing a program for generating data to control a spatial light modulator for shaping a light pulse for laser processing, the program causing a computer to execute:
setting information regarding a plurality of mutually different temporal-intensity waveforms each including a plurality of light pulses;
generating each of a plurality of sets of an intensity spectrum function and a phase spectrum function based on each of the plurality of temporal-intensity waveforms;
generating each of a plurality of pieces of data based on each of the plurality of sets of the intensity spectrum function and the phase spectrum function; and
calculating a generation efficiency in the spatial light modulator for each of the plurality of temporal-intensity waveforms based on each of the plurality of pieces of data and determining data for controlling the spatial light modulator from among the plurality of pieces of data based on the generation efficiency.
